(19) United States
(12) Patent Application Publication
(10) Pub. No.: US 2006/0116902 A1
(43) Pub. Date: Jun. 1, 2006

(54) Method and apparatus for workflow

(75) Inventors: Rich Amador, Fullerton, CA (US); Richard R. Neugebauer, Huntington Beach, CA (US)

Correspondence Address: FITZPATRICK CELLA HARPER & SCINTO, 30 ROCKEFELLER PLAZA, NEW YORK, NY, 10112, US

(73) Assignee: Canon U.S.A., Inc., Lake Success, NY (US)

(21) Appl. No.: 11/000,272

(22) Filed: Nov. 29, 2004

(51) Int. Cl. G06Q 10/00

(52) U.S. Cl. 705/2

(57) ABSTRACT

A method and apparatus for the management of radiological images generated by mobile radiological imaging systems. A Mobile Access Station (MAS) server is coupled to a hospital's data management systems. The MAS server is coupled to a mobile radiological imaging system via a MAS client. The MAS server receives study orders from the hospital's data management systems and generates worklist information for the mobile radiological imaging systems. The MAS client receives the worklist information from the MAS server and a technologist takes radiological images in accordance with the orders presented by the worklist information. The MAS client transmits the images for the study back to the MAS server. The technologist uses the MAS server to evaluate the quality of the collected images. If the quality of an image is unacceptable, the image is rejected and a new worklist is generated for collection of a replacement image. Once all of the images of a study are collected and determined to be acceptable, the images are transmitted by the MAS server to the hospital's data systems.

another example, some imaging systems rely on energy radiated by the patient's body itself, such as infrared radiation, to form images of soft tissue structures within or just below a patient's skin. As radiology systems may be based on various types or modes of energy, the term “modality” has come to be applied to radiological imaging systems.

Radiology departments are generally centrally located within hospital settings. Modalities, such as x-ray based imaging systems, found in these radiology departments are typically large and fixed within a room. Large fixed x-ray systems may use film or use a digital device to record x-ray images.

A technologist's job is to image the patient according to orders issued by a medical doctor. The technologist generally manipulates the patient and the modality in order to take a series of images. A collection of images for one order is herein termed a “study”.

When radiological images of a patient are required to be taken outside of the main radiology department, portable x-ray systems exist to provide x-ray procedures at a patient's bedside. This might be in the emergency room, in the operating suite, in intensive care or in a medical surgical floor. Traditionally, portable x-rays have been taken using x-ray film cassettes, requiring “wet” processing of the x-ray film in the radiology department. In this case, even though the collection of images was done outside of the radiology department, development of the x-ray film still entailed a centralized image processing system.

Some manufacturer's have now introduced “portable” x-ray sensor panels, replacing the traditional x-ray film cassette. This portable sensor panel is tethered to a mobile x-ray system, which includes a portable computer for the user interface and image development. While freeing the digital x-ray system from the confinement of a radiological department simplifies the collection of x-ray images, mobility introduces a new set of challenges.

One challenge introduced by the mobile x-ray systems is how to keep the systems synchronized with a hospital's data systems. These systems manage patient information, such as patient demographics, scheduling of exams and image management. Unlike the x-ray department where a local area network exists, providing portable x-ray services to outlying departments requires producing digital x-rays with no means of “plugging in” to a network for communicating with the hospital's data systems. Although connecting the mobile x-ray systems to a wireless network is an option, wireless networks are not yet ubiquitous in hospitals.

Without a bedside network or wireless environment, the technologist is forced to manually manage collection of the images for a study. For example, the technologist must determine which patients need to be imaged and enter each patient's information for association with the study directly into the mobile x-ray system. After the images are collected, the technologist must later access a hospital's network to upload images into the hospital's data systems. Manually managing image collection in this way may introduce mistakes in the manual patient data entry, thus resulting in inefficiencies in the hospital's data systems. In addition, there are medical and legal issues raised if a patient's x-ray is given someone else's name as the interpretation of the flawed study could result in treatment or nontreatment to the wrong patient.

Another problem that may arise is if an image is unacceptable and needs to be retaken. This determination is generally made after the images have been collected for a study and the images are evaluated at a centralized quality assurance system. In the event that an image has to be repeated, the mobile x-ray system has to be taken back to the patient's bedside, the image retaken and the mobile x-ray system once more moved to a point of network connection. As the study is already considered to be complete by the mobile x-ray system, any repeated images will be considered to be “orphaned” from the original study. This generally requires creation of a new study with the inherent possibility of incorrectly entering patient information.

Therefore, a need exists for an image work flow system that allows the efficient collection and management of images generated by mobile x-ray systems in a clinical environment. Various aspects of the present invention meet such a need.

### SUMMARY OF THE INVENTION

A method and apparatus are provided for the management of radiological images generated by mobile radiological imaging systems. A Mobile Access Station (MAS) server is coupled to a hospital's data management systems through a communications network. The MAS server is coupled to a mobile radiological imaging system via a MAS client. The MAS server receives study orders from the hospital's data management systems and generates worklist information for the mobile radiological imaging systems. A MAS client associated with a radiological imaging system receives the worklist information from the MAS server and a technologist takes radiological images in accordance with the orders presented by the worklist information. The MAS client then transmits the images for a study to the MAS server. The technologist uses the MAS server to evaluate the quality of the collected images. If the quality of an image is unacceptable, the image is rejected and new worklist information is generated for collection of a replacement image. Once all of the images of a study are collected and determined to be acceptable, the images are transmitted by the MAS server to the hospital's data systems.

In one aspect of the invention, an apparatus for managing generation of a set of images by a mobile modality includes a MAS server coupled to a Digital Imaging and Communications in Medicine (DICOM) Storage Class Provider (SCP), a Clinical Information System (CIS) and the mobile modality. The MAS server has a worklist component for generating worklist information from study order request messages received from the CIS. The worklist information is generated for transmitting to the mobile modality. The MAS server further includes an image quality assurance component for reviewing images from the mobile modality and generating a set of acceptable images for transmission to the DICOM SCP.

In another aspect of the invention, a MAS client couples the MAS server to the mobile modality. The MAS client includes a component for receiving the worklist information including study orders and a component for capturing, serializing and encrypting the intermediate set of images from images recorded by the mobile modality for the selected patient.

In another aspect of the invention, the MAS server further includes a local storage device and is coupled to the DICOM SCP via a communications network supporting communications using a DICOM protocol.

In another aspect of the invention, the MAS server is coupled to the CIS via a communications network supporting communications using Health Level 7 (HL7 ) messages.

In another aspect of the invention, the MAS server is coupled to the MAS client using a Portable Storage Medium (PSM). Images are stored on the PSM in an encrypted format for transfer to the MAS server.

In another aspect of the invention, the MAS server is coupled to the MAS client over a communications network. The communication network may be wired or wireless. The images are transmitted from the MAS client to the MAS server in an encrypted format.

In another aspect of the invention, a method is provided of managing generation of a set of images by a mobile modality. The method includes generating worklist information by a server from order request messages received from a CIS. The worklist information is then transmitted by the server to a mobile modality. A technologist generates an intermediate set of radiological images based on the worklist information. The server then receives the intermediate set of images from the mobile modality and processes a set of acceptable images from the intermediate set of images. The MAS server transmits the set of acceptable images to a DICOM SCP.

In another aspect of the invention, processing by the server of the set of intermediate images further includes displaying the intermediate images to an operator. The operator identifies a selection of acceptable images from among the intermediate images, thus allowing the server to separate the intermediate images into a set of images deemed acceptable and a set of images deemed unacceptable. Worklist information corresponding to the set of images deemed unacceptable may then be merged back into the worklist information by the server. Images that are retaken to replace the unacceptable images are merged back into the grouping of the original images using the patient identifier and other markers to determine the correct group to associate with the retaken images.

In another aspect of the invention, the images transferred between the server and the mobile modality are encrypted. Furthermore, when the server transfers the set of acceptable images to the DICOM SCP, the set of images is included in a DICOM data object.

In another aspect of the invention, the order request messages are defined as formatted messages. As an example, the messages may be formatted using a format specified as a HL7 message.

This brief summary has been provided so that the nature of the invention may be quickly understood. A more complete understanding of the invention may be obtained by reference to the following detailed description in connection with the attached drawings.

### BRIEF DESCRIPTION OF THE DRAWINGS

FIG. 1 is a block diagram of a traditional radiological imaging system in a clinical setting.

FIG. 2 is a sequence diagram of a traditional radiological imaging system image collection procedure.

FIG. 3 is a deployment diagram of a radiological imaging system having mobile modalities in accordance with an exemplary embodiment of the present invention.

FIG. 4 is a deployment diagram of a MAS server coupled to a MAS client in accordance with an exemplary embodiment of the present invention.

FIG. 5 is a sequence diagram of a worklist information generation and image collection process in accordance with an exemplary embodiment of the present invention.

FIG. 6 is a sequence diagram of a worklist information updating process in accordance with an exemplary embodiment of the present invention.

FIG. 7 is a process flow diagram of an image quality assurance procedure in accordance with an exemplary embodiment of the present invention.

FIG. 8 is an architecture diagram for a data processing system, such as a general purpose computing machine, suitable for hosting a MAS server in accordance with an exemplary embodiment of the present invention.

FIG. 9 is an architecture diagram for a data processing system, such as a general purpose computing machine, suitable for hosting a MAS client in accordance with an exemplary embodiment of the present invention.

### DETAILED DESCRIPTION

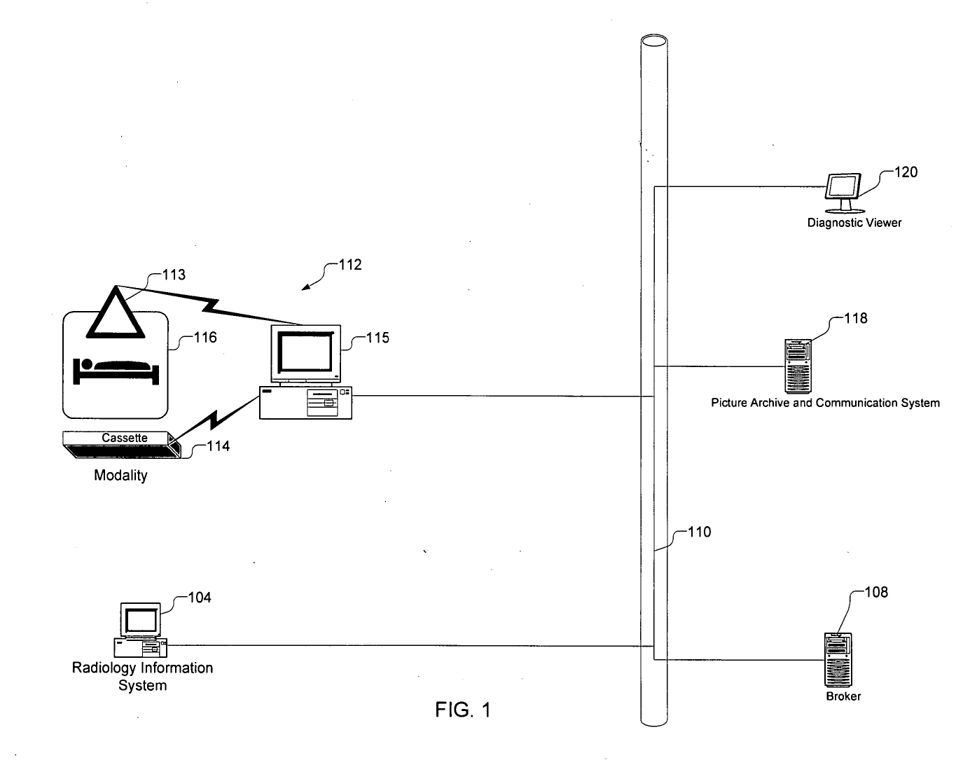

FIG. 1 is a block diagram of a traditional radiological imaging system in a clinical setting. A radiology information system 104 is coupled to a broker 108 over computer network 110. The radiology information system includes patient data and requests for radiological services to be performed. Generally, the data stored in the radiology information system is transferred between other information system in the hospital using formatted messages, such as Health Level 7 (HL7 ) messages. HL7 defines the format for the order of the messages. Because the formats of the messages have been defined by HL7, systems may read the data contained therein, and know how to parse out any desired information, such as patient name, order, date, etc. HL7 relies on the standard Ethernet protocol for low level connectivity. The broker provides translation services for communications between the radiology information system and DICOM modalities coupled to the network.

A traditional radiology imaging system further includes one or more modalities, such as modality 112, for generating radiological images. A typical modality includes an energy source 113, such as an x-ray source, and an image recording device 114, such as a digital recorder 114. The modality further includes a controller 115, such as a programmable computer, for controlling the modality, providing a user interface for a technologist using the modality and providing a communications interface to other systems. The technologist uses the modality to collect images for a radiological study of a patient 116.

A traditional radiological imaging system further includes a picture archive and communications system 118 coupled to the network. The picture archive and communications system is used to store radiological images. Typically, the picture archive and communications system communicates to other systems using a data modeling protocol such as as Digital Imaging and Communications in Medicine (DICOM). A radiologist accesses the images stored on the picture archive and communications system using a diagnostic viewer 120 coupled to the picture archive and communications system.

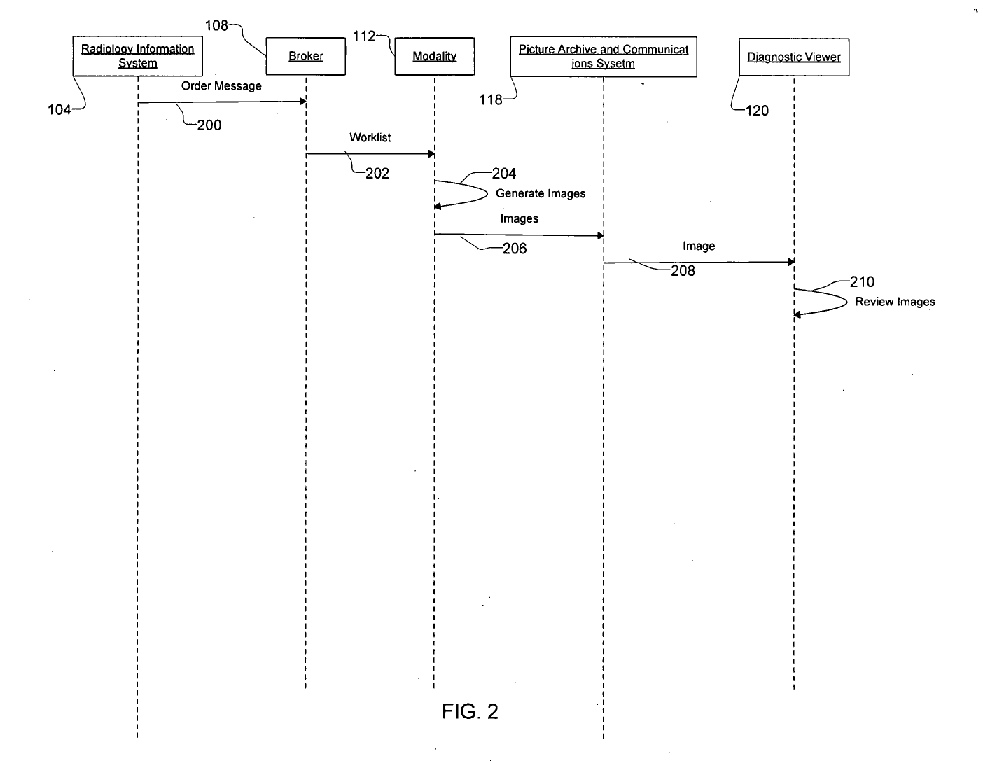

FIG. 2 is a sequence diagram of a traditional radiological image collection procedure. A user enters patient data and radiological study requests into a radiology information system. The radiology information system generates an order message 200 for transmission to a broker 108. Typically, the order message is formatted using HL7. The broker receives the order message and generates a worklist 202 for transmission to a modality 112. The worklist is typically in a data modeling language such as DICOM. As such, the broker provides translation services between systems using HL7 and systems using DICOM for communications.

The modality receives the worklist and a technologist generates (204) images 206 based on the contents of the worklist. The modality encapsulates the images as a data object specified by DICOM and transmits the images to a picture archive and communications system 118. The images are archived until a radiologist accesses the images using a diagnostic viewer 120. Finally, the radiologist reviews (210) the images using the diagnostic viewer.

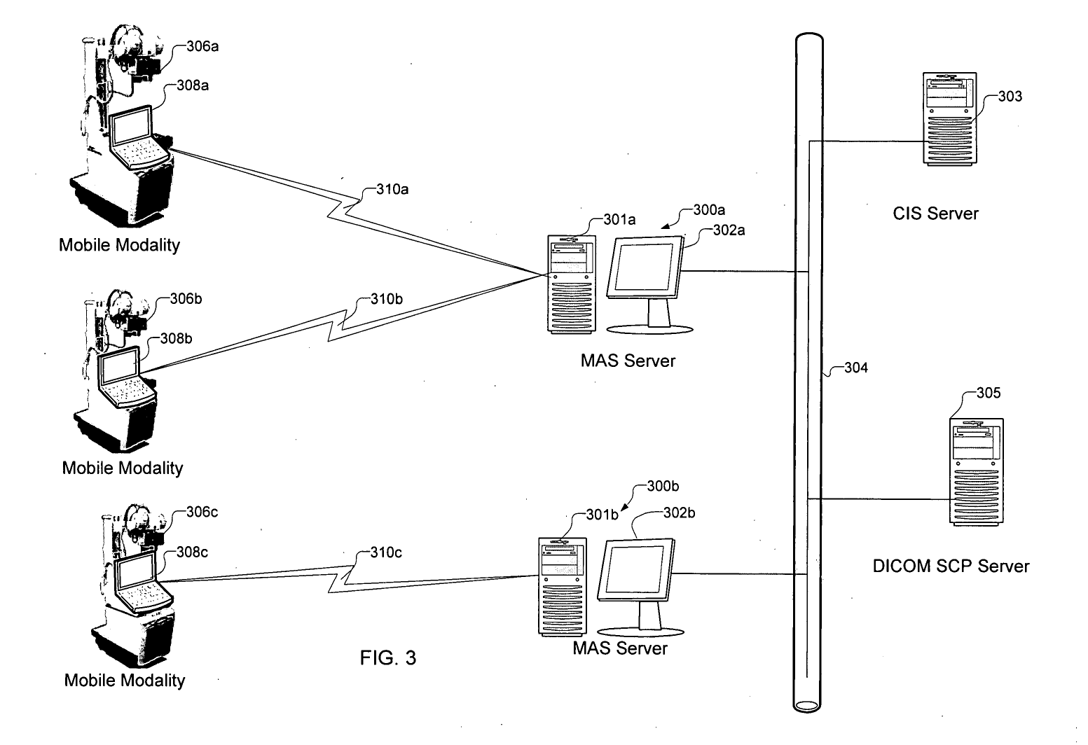

FIG. 3 is a deployment diagram of a radiological imaging system having mobile modalities in accordance with an exemplary embodiment of the present invention. The radiological imaging system includes one or more Mobile Access System (MAS) servers, such as MAS servers 300a and 300b. Each MAS server may include a processor or controller, such as programmable computers 301a and 301a, for controlling the operations of the MAS server. The MAS server may also include a display device, such as display devices 302a and 302b, for displaying radiological images to a technologist.

Each MAS server is coupled to one or more Clinical Information Systems (CISs), such as CIS server 303, via a communications network 304. The CISs are used by a hospital's staff to manage patent data and to generate requests for procedures such as radiological imaging of patients. Typically, the CISs communicate with other systems over the communications network using HL7.

Each MAS server is also coupled to one or more image management systems via the communications network. Typically, the image management systems communicate with other systems using DICOM, such as DICOM SCP server 305.

Each MAS server is further coupled to one or more mobile modalities. For example, MAS server 300a is coupled to two mobile modalities, 306a and 306b, whereas MAS server 300b is coupled to a single mobile modality 306c. Each mobile modality includes a programmable controller, such as portable computers 308a, 308b and 308c, that control operations of the mobile modalities. The mobile modalities are coupled to the MAS servers via communications links 310a, 310b and 310c. The physical layer of the communications link may take several forms. For example, the physical layer of the communications link may be wireless, a wired, or a Portable Storage Medium (PSM) device that may be coupled and decoupled to the MAS server and mobile modality.

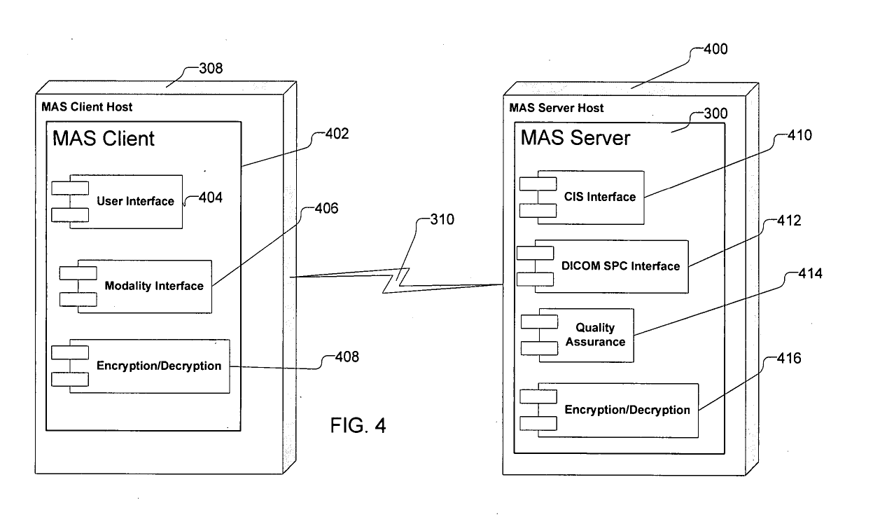

FIG. 4 is a deployment diagram of a MAS server coupled to a MAS client in accordance with an exemplary embodiment of the present invention. A MAS server 300 is hosted by a MAS server host 400. The MAS server includes modules or software components for communications with other systems via a communications network. For example, the MAS server may include a CIS interface 410 for communication with CIS 303 (of FIG. 3) and a DICOM SCP interface 412 for communications with DICOM SCP 305 (of FIG. 3). The MAS server may also include a quality assurance component 414 having a user interface for displaying images to a user so that the user may select acceptable images and reject unacceptable images. Finally, the MAS server may include an encryption/decryption module for encrypting and decrypting data sent from and to the MAS server.

The MAS server is coupled to a MAS client 402 hosted on a MAS client host 308, such as portable computer 308a (of FIG. 3) via a communications link 310. As described previously, the communications link may employ a variety of physical layers. The MAS client may include a user interface component 404 for displaying status information to the technologist. The MAS client may include a modality interface 406 for issuing commands to a modality and receiving image data. Finally, the MAS client may include an encryption/decryption component for encrypting and decrypting data sent to and received from the MAS server.

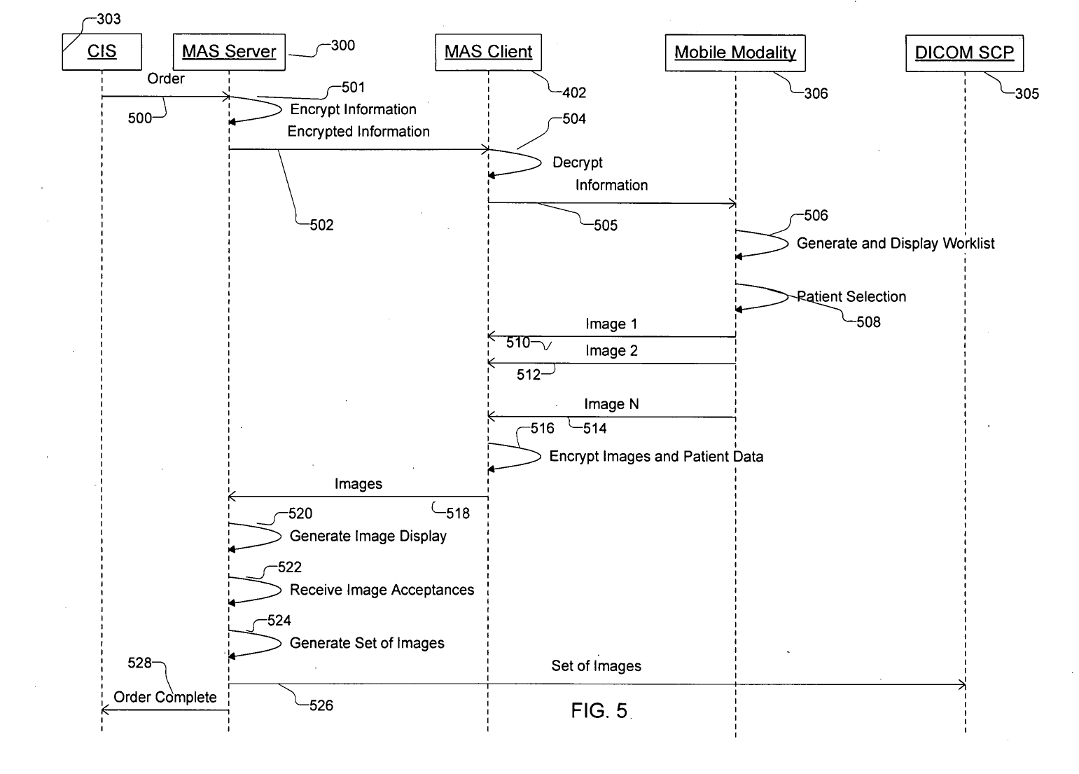

FIG. 5 is a sequence diagram of a worklist information generation and image collection process in accordance with an exemplary embodiment of the present invention. In operation, a MAS server 300 receives requests or orders 500 from CIS 303 for studies of patients. The MAS server parses the messages in order to extract worklist information including patient identifier information and image type information, such as a request for a specific radiographic examination of the patient, used by a technologist to capture images for the study. The MAS server encrypts (501) the extracted study information and then transmits the encrypted patient information and study information 502 to a MAS client 402. This information is then decrypted 504 by the MAS client and transmitted as formatted information 505 to a mobile modality 306. The mobile modality creates (506) a worklist and displays the worklist to the technologist who is responsible for acquiring the images for the study. In response to the display, the technologist uses the mobile modality to select (508) a patient. The mobile modality then steps through the study transmitting one or more images, such as images 510, 512 and 514, from the mobile modality to the MAS client. The images are encrypted (516) by the MAS client into an intermediate set of images 518 or study that is transmitted back to the MAS server.

During a quality assurance phase, the MAS server decrypts the images and generates (520) image displays for review by the technologist. The MAS server receives (522) image acceptances from the technologist who is reviewing the images. Any rejected images may be used as part of a new worklist for transmission to the MAS client. Once all of the images for a study have been accepted, the MAS server generates (524) a final set of images 526 or study for transmission to an image storage device, such as DICOM SCP 305.

In one embodiment of the MAS server, the MAS server transmits an order completion message 528 to the CIS. The CIS uses the order completion message to update the status of pending orders.

In one MAS server and MAS client system in accordance with an exemplary embodiment of the present invention, the MAS server communicates with the CIS using messages in an HL7 communications protocol. The MAS server receives orders for studies in HL7 and then translates the orders into a neutral or proprietary format for transmission to the MAS client.

In another MAS server and MAS client system in accordance with an exemplary embodiment of the present invention, the MAS server receives images from the MAS client in a neutral or proprietary format and transforms the images into a DICOM data object for transmission to the DICOM SCP.

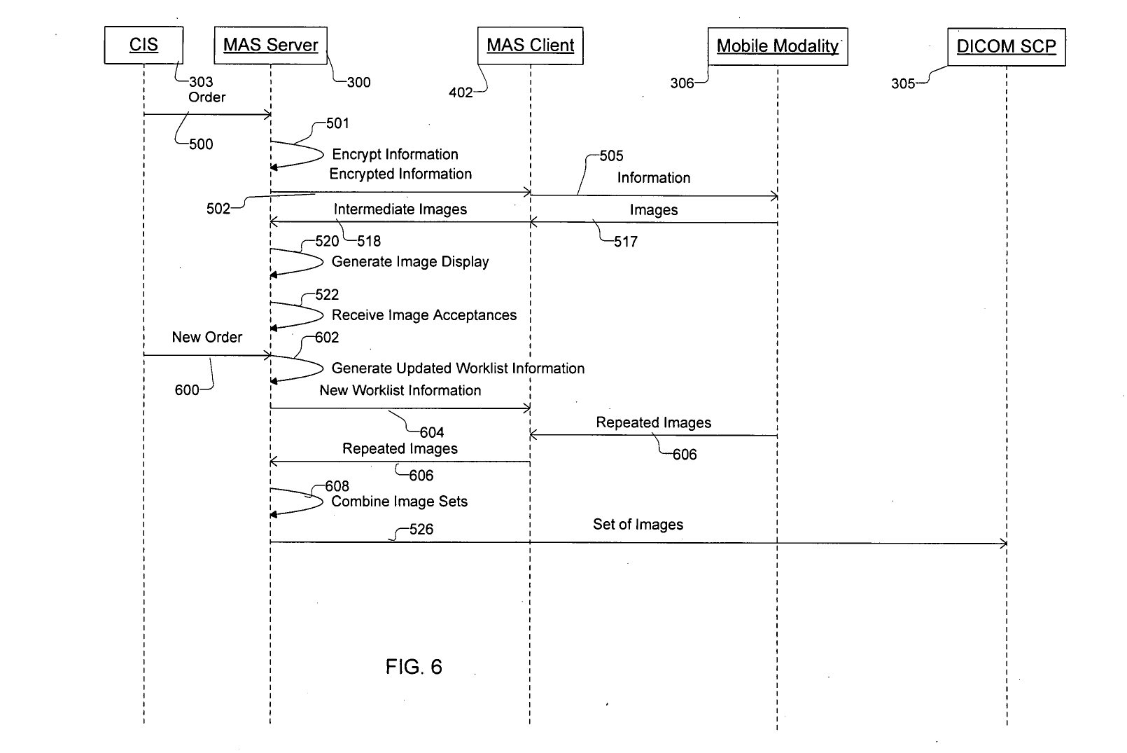

FIG. 6 is a sequence diagram of a worklist updating process in accordance with an exemplary embodiment of the present invention. During the worklist updating process, new orders may be added to a worklist or replacement images may be ordered to replace images that were found to be unacceptable for inclusion in a study. The new worklist may then be pushed onto the MAS client by the MAS server each time the MAS client is coupled to the MAS server.

During the worklist process, a CIS 303 transmits an order 500 to a MAS server 300. The MAS server receives the order and the MAS server encrypts (501) and then transmits the encrypted patient information and study information 502 to a MAS client 402 for processing as previously described. The MAS client transmits formatted information 505 to the mobile modality as previously described. The MAS client then receives images 517 from the mobile modality. The MAS client then transmits these images as sets of intermediate images 518 corresponding to studies in the worklist from the mobile modality as previously described. The MAS server generates (520) image displays for a technologist to accept or decline each image in a study. The MAS server receives (522) acceptances from the technologist and keeps track of unaccepted images. The MAS server uses the unaccepted image information as well as new orders 600 to generate (602) updated worklist information 604, including worklist information corresponding to the unaccepted images, that is transmitted to the MAS client. The MAS client uses the updated worklist to prompt the technologist to capture a set of repeated images 606 that is transmitted to the MAS server. The MAS server receives the repeated images and combines (608) them with their corresponding studies to form a complete set of accepted images 526 for transmission to the DICCOM SCP 305.

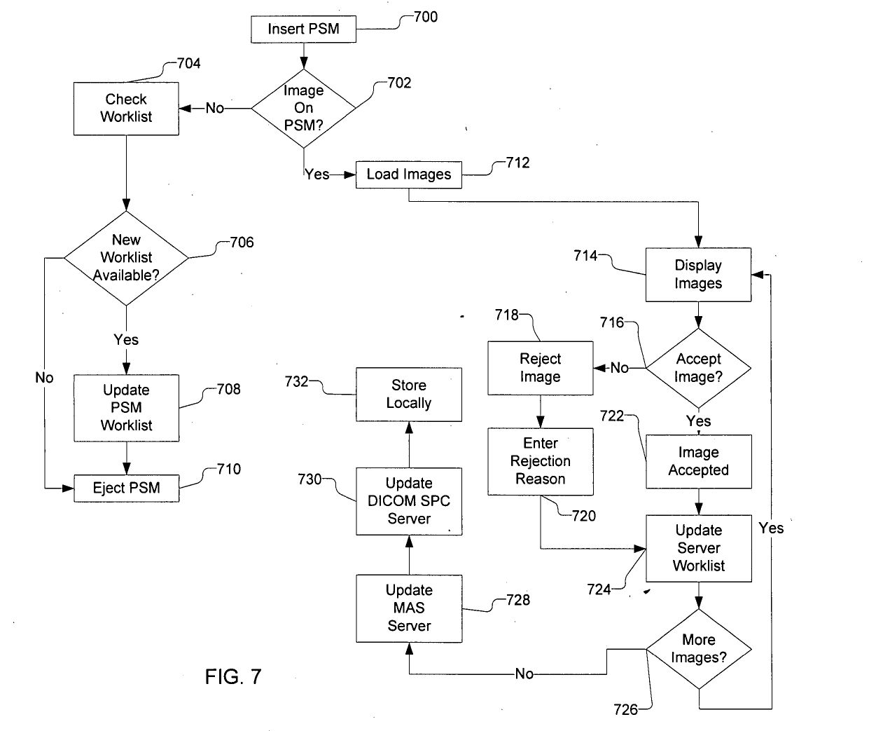

FIG. 7 is a process flow diagram of an image quality assurance procedure in accordance with an exemplary embodiment of the present invention. In the depicted process implemented on a MAS server, a PSM is the physical medium used in a communications link between a MAS server and a MAS client. In the process, the PSM is inserted (700) into a connection port on the MAS server. The MAS server queries the PSM and determines (702) if there are images stored on the PSM. If not, the MAS server checks (704) to see if a new worklist order is available. If it is determined (706) that new worklist information is available, the MAS server updates the (708) modality worklist information the PSM and ejects (710) the PSM for use in a mobile modality. If no new worklist information is available, the MAS server simply ejects the PSM.

If the MAS server determines that there are images stored on the PSM, the MAS server loads (712) and decrypts the images. The images are then displayed (714) to a technologist for review. If the technologist does not accept (716) an image, the MAS server rejects (718) the image from inclusion in the ordered study. For each rejected image, the MAS server requests (720) a rejection reason to be entered by the technologist. The reason is stored with the study for reporting purposes. In addition, for each rejected image, an order for a repeat image is used for updating (724) the worklist information. If an image is accepted (722) the worklist information is updated such that the new worklist information reflects that the image has been accepted. The acceptance or rejection of images is repeated (726) until there are no more images to review.

Once all of the images have been reviewed, the MAS server is updated (728) reflecting the completion of ordered studies and the need for repeated images. All of the completed studies are used to update (730) the DICOM SCP. In addition, the MAS server may locally store (732) images as needed for additional review or other purposes.

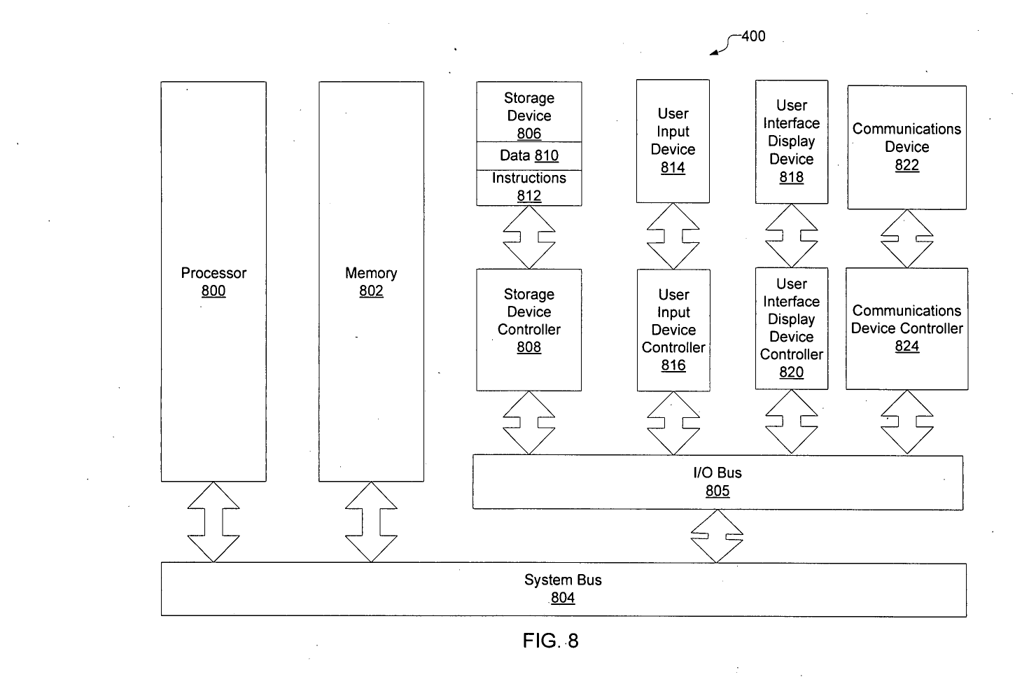

FIG. 8 is an architecture diagram for a data processing system, such as a general purpose computing machine, suitable for hosting a MAS server in accordance with an exemplary embodiment of the present invention. The data processing system 400 includes a processor 800 coupled to a memory 802 via system bus 804. The processor is also coupled to external Input/Output (I/O) devices via the system bus and an I/O bus 805. A storage device having computer system readable media 806 is coupled to the processor via a storage device controller 808 and the I/O bus and the system bus. The storage device is used by the processor to store and read data 810 and program instructions 812 used to implement the features of a MAS server as described above.

The processor may be further coupled to a user output device 818 via a user output device controller 820 coupled to the I/O bus. The processor uses the user output device to display images to a technologist for review and acceptance or rejection.

The processor may be further coupled to a user input device 814 via a user input device controller 816 coupled to the I/O bus. The processor uses the user input device to receive selections of images from a technologist for acceptance or rejection.

The processor may be further coupled to a communications device 822 via a communications device controller 824 coupled to the I/O bus. The processor uses the communications device to communicate with a MAS client, a CIS, and a DICOM SCP as previously described. In some MAS servers, the physical medium used for a communications link with the MAS client may be a PSM as previously described. In these embodiments, the communications device is a port that couples the PSM to the MAS server.

In operation, the processor loads the program instructions from the storage device into the memory. The processor executes the loaded program instructions to receive study orders, generate worklists, receive intermediate sets of images and generate final sets of images for transmission to an image archive as described above.

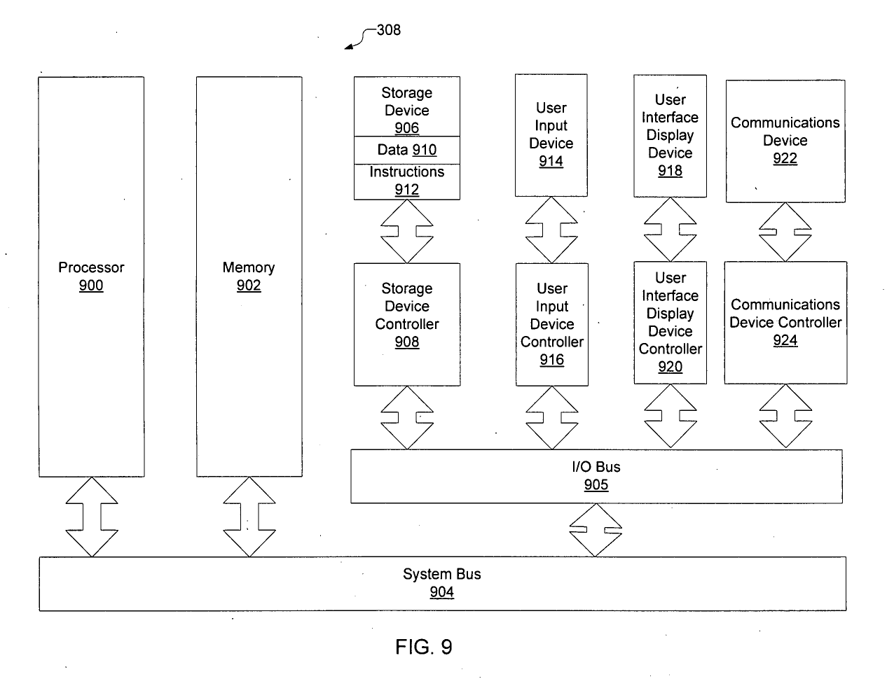

FIG. 9 is an architecture diagram for a data processing system, such as a general purpose computing machine, suitable for hosting a MAS client in accordance with an exemplary embodiment of the present invention. The data processing system 308 includes a processor 900 coupled to a memory 902 via system bus 904. The processor is also coupled to external Input/Output (I/O) devices via the system bus and an I/O bus 905. A storage device having computer system readable media 906 is coupled to the processor via a storage device controller 908 and the I/O bus and the system bus. The storage device is used by the processor to store and read data 910 and program instructions 912 used to implement the features of a MAS server as described above.

The processor may be further coupled to a user output device 918 via a user output device controller 920 coupled to the I/O bus. The processor uses the user output device to display a worklist to a technologist and to prompt the technologist during an image collection process.

The processor may be further coupled to a user input device 914 via a user input device controller 916 coupled to the I/O bus. The processor uses the user input device to receive selections of studies from a technologist for processing.

The processor may be further coupled to a communications device 922 via a communications device controller 924 coupled to the I/O bus. The processor uses the communications device to communicate with a MAS server as previously described. In some MAS clients, the physical medium used for a communications link with the MAS server may be a PSM as previously described. In these embodiments, the communications device is a port that couples the PSM to the MAS client.

In operation, the processor loads the program instructions from the storage device into the memory. The processor executes the loaded program instructions to receive worklists, display worklists, receive study selections and generate intermediate sets of images for transmission to a MAS server as described above.

The present invention has been described above with respect to particular illustrative embodiments. It is understood that the present invention is not limited to the above-described embodiments and that various changes and modifications may be made by those skilled in the relevant art without departing from the spirit and scope of the invention.

What is claimed is:

1. An apparatus for managing generation of a set of images by a mobile modality, comprising:
a Mobile Access Station (MAS) server coupled to a Digital Imaging and Communications in Medicine (DICOM) Storage Class Provider (SCP), a Clinical Information System (CIS) and the mobile modality, the MAS server comprising:
a worklist module for generating worklist information from study order request messages received from the CIS, the worklist information for transmitting to the mobile modality; and
an image quality assurance module for reviewing images from the mobile modality and generating a set of acceptable images for transmission to the SCP.

2. The apparatus of claim 1, further comprising a MAS client coupling the MAS server to the mobile modality, the MAS client comprising:
a module for receiving the worklist information including study orders; and
a module for capturing, serializing and encrypting the intermediate set of images from images recorded by the mobile modality for the selected patient.

3. The apparatus of claim 1, wherein the MAS server is coupled to the SCP via a communications network supporting communications using a DICOM protocol and further comprises a local storage device.

4. The apparatus of claim 1, wherein the MAS server is coupled to the CIS via a communications network supporting communications using Health Level 7 (HL7 ) formatted messages.

5. The apparatus of claim 2, wherein the MAS server is coupled to the MAS client using a Portable Storage Medium (PSM).

6. The apparatus of claim 5, wherein the set of intermediate images is stored in the PSM, in an encrypted format.

7. The apparatus of claim 2, wherein the MAS server is coupled to the MAS client over a communications network.

8. The apparatus of claim 7, wherein the communications network is a wired communications network.

9. The apparatus of claim 7, wherein the communications network is a wireless network.

10. The apparatus of claim 7, wherein the set of intermediate images is transmitted in an encrypted format.

11. A method of managing generation of a set of images by a mobile modality, comprising:
generating worklist information by a server from order request messages received from a CIS;
transmitting the worklist information by the server to a mobile modality;
receiving an intermediate set of images by the server from the mobile modality, the intermediate images generated by the mobile modality on the basis of the worklist information;
processing by the server a set of acceptable images from the intermediate set of images; and
transmitting by the server the set of acceptable images to a SCP.

12. The method of claim 11, wherein the worklist information includes a patient identifier and a request for a specific radiographic examination of the patient.

13. The method of claim 11, wherein processing by the server the set of images further comprises:
displaying the intermediate images to an operator;
identifying a selection of images from among the intermediate images;
separating a set of images deemed acceptable; and
separating a set of images deemed unacceptable.

14. The method of claim 13, wherein worklist information corresponding to the set of images deemed unacceptable is merged back into the worklist information by the server.

15. The method of claim 13, wherein images that are retaken to replace the unacceptable images are merged back into the grouping of the original images using markers including a patient identifier to determine a correct group to associate with the new image.

16. The method of claim 11, wherein the set of intermediate images is encrypted by the mobile modality.

17. The method of claim 11, wherein the order request messages are defined formatted messages.

18. The method of claim 17, wherein the format is included in a HL7 protocol.

19. The method of claim 11, wherein the set of images is a DICOM data object.

20. A computer-readable medium storing instructions executable by a data processing system to manage generation of a set of images by a mobile modality, the instructions comprising generating worklist information from order request messages received from a CIS;
transmitting the worklist information to a mobile modality;
receiving an intermediate set of images from the mobile modality, the intermediate images generated by the mobile modality on the basis of the worklist information;
processing a set of acceptable images from the intermediate set of images; and
transmitting the set of acceptable images to a SCP.

21. The method of claim 20, wherein the worklist information includes a patient identifier and a request for a specific radiographic examination of the patient.

22. The method of claim 20, wherein processing by the server the set of images further comprises:
displaying the intermediate images to an operator;
identifying a selection of images from among the intermediate images;
separating a set of images deemed acceptable; and
separating a set of images deemed unacceptable.

23. The method of claim 22, wherein worklist information corresponding to the set of images deemed unacceptable is merged back into the worklist information by the server.

24. The method of claim 22, wherein images that are retaken to replace the unacceptable images are merged back into the grouping of the original images using markers including a patient identifier to determine a correct group to associate with the new image.

25. The method of claim 20, wherein the set of intermediate images is encrypted by the mobile modality.

26. The method of claim 20, wherein the order request messages are defined formatted messages.

27. The method of claim 26, wherein the messages are formatted using Health Level 7 (HL7 ) formatting.

28. The method of claim 20, wherein the set of images is a DICOM data object.
